(19) United States
(12) Patent Application Publication
(10) Pub. No.: US 2012/0046791 A1
(43) Pub. Date: Feb. 23, 2012

(54) METHOD OF IMPROVING PERFORMANCE OF SMA ACTUATOR

(75) Inventors: Xiujie Gao, Troy, MI (US); Alan L. Browne, Grosse Pointe, MI (US); Nancy L. Johnson, Northville, MI (US); Guillermo A. Herrera, Winnetka, CA (US); Geoffrey P. Mc Knight, Los Angeles, CA (US); Robert B. Gorbet, Kitchener (CA); Hien K. Goi, Mississauga (CA); Eric Gregory Kubica, Kitchener (CA); Mohamed El Dib, Mississauga (CA); Vidyashankar R. Buravalla, Bangalore (IN); Ashish Khandelwal, Bangalore (IN)

(73) Assignee: GM GLOBAL TECHNOLOGY OPERATIONS, INC., DETROIT, MI (US)

(21) Appl. No.: 12/860,937

(22) Filed: Aug. 23, 2010

(51) Int. Cl. G05B 15/02

(52) U.S. Cl. 700/275

(57) ABSTRACT

A method of improving the speed and consistency of response of a shape memory alloy actuator under varying ambient and operating conditions. The method includes probing the shape memory alloy by periodically determining an electric signal strength at which it will undergo forward or reverse phase transformation, while avoiding actual phase transformation; priming the shape memory alloy by bringing it close to phase transformation; initiating phase transformation; and maintaining the shape memory alloy in the phase transformed state. The electric signal strength at which the shape memory alloy will undergo phase transformation is determined by identifying a cusp feature in the electric resistance of the shape memory alloy which closely precedes phase transformation.

### BACKGROUND OF THE INVENTION

1. Technical Field

Generally, the present invention is related to systems for and methods of improving the performance of a shape memory alloy actuator under varying conditions. More specifically, the present invention concerns a system for and method of improving the speed and consistency of response of a shape memory alloy actuator by using feedback to determine and periodically re-determine the approximate electric signal strength required to heat or cool the shape memory alloy to its phase transformation temperature under existing ambient and operating conditions.

2. Background Art

Shape memory alloys (SMAs) undergo a temperature-dependent phase transformation between an austenitic and a martensitic structure, which causes a change in material properties, notably the modulus of elasticity. If the SMA is subject to external loads, this transformational behaviour can be used to create a thermo-mechanical actuator. Typical SMA wire or spring actuators have electric connections at both ends for receiving a control current. The control current increases the temperature of the SMA by resistance heating, and thereby controls the phase transformation and contraction or expansion of the actuator, thereby creating an electro-mechanical actuator.

SMA actuators are typically used in one of two modes: positioning and “on-off” actuation. In positioning applications, it is desirable to precisely control the contraction or expansion, and thus the phase fraction, to achieve a desired position. However, the relationships between current and temperature, and between temperature and phase fraction, are nonlinear and hysteretic, making precise control difficult to achieve.

In “on-off” applications, the SMA is simply heated or cooled beyond its actuation temperature to achieve full contraction or expansion for a given load. However, the amount of power required to heat or cool the SMA beyond its actuation temperature depends on ambient and operating conditions, such as the ambient temperature and convection conditions. Thus, fixed-current actuation will not produce repeatable performance under different ambient conditions, and may completely fail to actuate under some conditions.

### BRIEF SUMMARY

The present invention provides a method of improving the performance, including improving the speed and consistency of response, of a shape memory alloy actuator under varying ambient and operating conditions. Broadly, the method comprises the steps of identifying a cusp feature in the electric resistance of the SMA as an indicator of an onset of phase transformation, and maintaining a maintenance signal to the SMA so that the electric resistance remains within a specified regime of the cusp, thereby maintaining the SMA in a primed state which facilitates subsequent actuation.

In various implementations, the method may further include any one or more of the following additional steps or features. Identifying the cusp may include, during heating of the SMA from a martensitic state, identifying an electric resistance value which, upon further heating, is followed by a decrease in the electric resistance leading to reverse phase transformation. Similarly, identifying the cusp may include, during cooling of the SMA from an austenitic state, identifying an electric resistance value which, upon further cooling, is followed by an increase in the electric resistance leading to forward phase transformation. Identifying the cusp may include applying an electric signal of increasing strength to the SMA; determining a slope of the electric resistance; and identifying a positive slope followed by successive negative slopes for reverse phase transformation. Similarly, identifying the cusp may include applying an electric signal of decreasing strength to the SMA; determining a slope of the electric resistance; and identifying a negative slope followed by successive positive slopes for forward phase transformation. Identifying the cusp may include using a model, using a model in conjunction with measured values for electric resistance or using a mathematical operation in conjunction with measured values for electric resistance to predict a strength of the electric signal corresponding to the cusp under existing conditions. It is preferred using electric resistance values measured during periods when a relatively high strength electric signal is applied to the SMA to improve the signal to noise ratio. In a contemplated application, the actuator is associated with a vehicle, and the step of identifying the cusp is performed in response to receipt of a signal from a vehicle user or sensor.

More consistent performance over a range of temperatures may be achieved by inserting a temperature-varying resistor in series with the SMA so that at lower temperatures the electric resistance is low and the voltage across the SMA is high such that more power is transferred to the SMA, and at higher temperatures the electric resistance is high and the voltage across the SMA is low such that less power is transferred to the SMA.

The method may further include the step of initiating the phase transformation by applying an initiation signal that is a function of the maintenance signal. In the aforementioned vehicle application, the initiation signal may be applied in response to a vehicle user or sensor.

The method may further include the step of storing the value of the initiation signal, and subsequently applying the electric signal having the approximate stored value to the SMA to facilitate actuation.

These and other aspects and advantages of the present invention are discussed in the following detailed description of the preferred embodiment(s) and depicted in the accompanying drawing figures.

### BRIEF DESCRIPTION OF THE SEVERAL VIEWS OF THE DRAWING

A preferred embodiment(s) of the invention is described in detail below with reference to the attached drawing figures, wherein:

FIG. 1 is a flowchart of steps involved in an embodiment of the method of the present invention;

FIG. 2 is a graph of electric signal strength versus electric resistance associated with a shape memory alloy; and

FIG. 3 is a block diagram of an embodiment of a system for implementing the method of FIG. 1.

### DETAILED DESCRIPTION

The present invention provides a method of improving the performance of a shape memory alloy actuator. More specifically, variations in temperature, heat transfer, mechanical loading conditions, and physical characteristics can affect the response time and performance of SMA materials, and the present invention is concerned with increasing the speed and consistency of response of an SMA actuator under varying ambient and operating conditions.

The method involves a multi-stage strategy to determine the control currents in the SMA actuator. The stages may be referred to as “probing” (stage A), “priming” (stage B), “actuation” (stage C), and “maintenance” (stage D). Each stage may be initiated in a variety of ways, some of which are described below, and the overall sequence of stages may vary depending on the intended application or other conditions. In some cases, the priming or maintenance stages may be omitted, but, in most cases, at least the probing and actuation stages will be included. Furthermore, for every actuation stage, the probing and priming stages may be repeated multiple times. For example, the actuator may progress from probing to priming, and, if no actuation trigger signal is received, may return to probing. Thus, an exemplary progression of stages might occur as follows: AAAABAABCDDAAA.

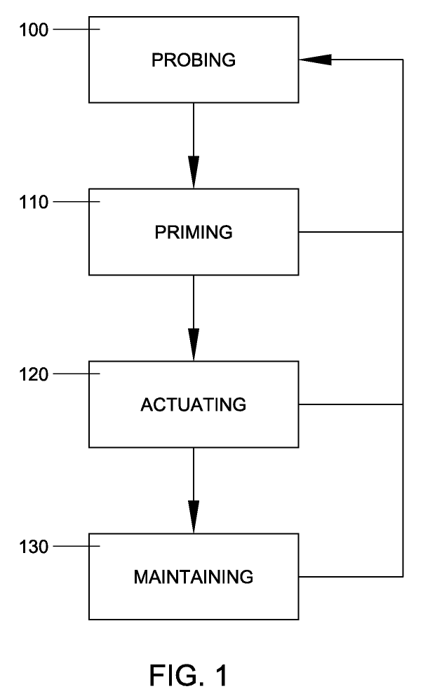

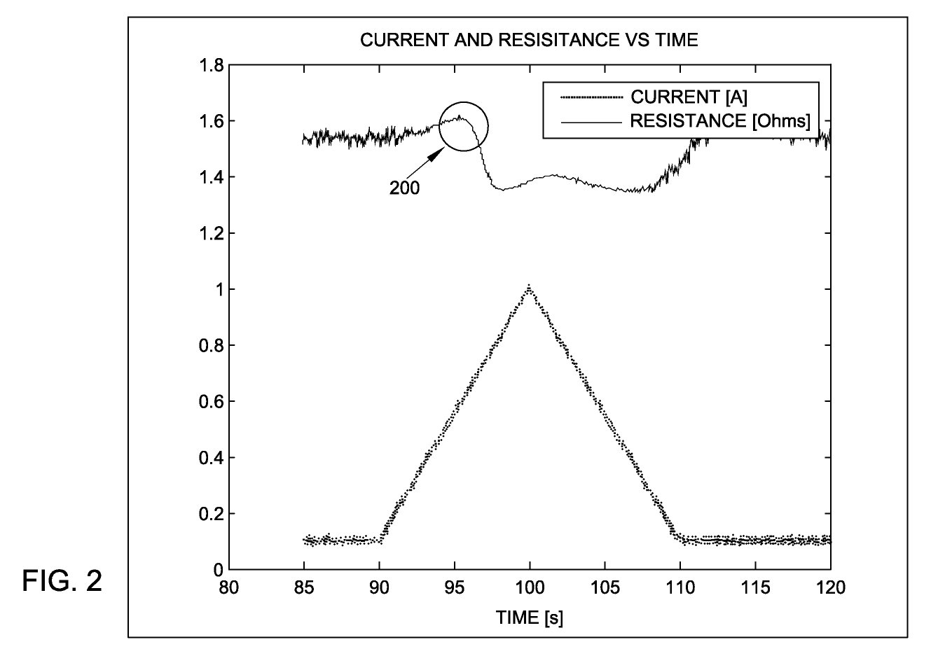

Referring to FIG. 1, these stages may be further characterized as follows. Probing 100 the SMA actuator involves periodically determining an approximate electric signal strength at which the SMA will reach its actuation temperature and undergo phase transformation, while avoiding actual phase transformation. Priming 110 the SMA actuator involves applying an electric signal having less strength than the approximate electric signal strength determined during probing, so that the SMA actuator increases in temperature but does not reach the actuation temperature. Actuating 120 the SMA actuator involves applying the last-determined approximate electric signal strength during probing. The initiation signal strength may be a mathematical manipulation such as scaling, offsetting, linear, non-linear or any combination of these of the last-determined approximate electric signal strength during probing. Referring to FIG. 2, the approximate electric signal strength at which the SMA actuator will reach the actuation temperature and undergo phase transformation may be determined by applying a probing signal of increasing or decreasing signal strength to the SMA actuator, detecting an electric resistance of the SMA actuator, and identifying the heating cusp 200 in the electric resistance which shortly precedes the reverse phase transformation, and identifying the cooling cusp 201 in the electric resistance which shortly precedes the forward phase transformation. Maintaining 130 actuation of the SMA actuator involves reducing the electric signal strength to a level sufficient to maintain the SMA actuator in the phase transformed state.

Although various exemplary embodiments, configurations, and implementations are depicted and described herein, these are meant to illustrate and support rather than limit unless expressly incorporated into the claims. For example, although the present invention is more generally concerned with “on-off” actuation, a number of its aspects can be applied to position control applications as well. Moreover, it is appreciated that all determinations described herein, including the cusp, as well as other feedback may be made by applying an initial signal to a dummy shape memory alloy element in close proximity to and congruently configured with the main SMA actuator, wherein the dummy and main elements are in the same zone of influence (e.g., ambient conditions).

In greater detail, the present invention provides a method of controlling the contraction (actuation via heating) or expansion (actuation via cooling) of an SMA actuator, whereby the SMA is utilized concurrently as both a sensor and an actuator. The SMA is controlled so that faster and more consistent performance is achieved, even if the SMA is subjected to variable heat transfer and variable mechanical loading conditions, without the use of dedicated sensors to detect these conditions, or if the SMA has unexpected physical characteristics that vary from design conditions (e.g., dimensions, composition, electric resistance) due to manufacturing/assembly tolerances or material change over time (herein referred to as “physical variations”).

In metallurgical terms, an SMA has two stable temperature- and stress-dependent crystalline structures known as “austenite” and “martensite”. Transformation from austenite to martensite is referred to as “forward phase transformation”, and transformation from martensite to austenite is referred to as “reverse phase transformation”. SMA actuator design capitalizes on the difference in material properties of the two phases, specifically the Young's modulus of elasticity, which is higher in the austenite phase than in the martensite phase. A thermally-controlled actuator may, for example, consist of an SMA wire under a constant stress; as the wire is heated beyond the reverse phase transformation temperature, the Young's modulus increases and the wire contracts; as the wire is cooled below the forward phase transformation temperature, the Young's modulus decreases with the accompanying formation of martensite and the wire expands.

Actuation may be accomplished, for example, by controlling an electric signal applied to the SMA to increase temperature via Joule heating, and using heat loss via natural or forced convection or conduction for cooling. Because the transformation in an SMA actuator is thermally-driven, the energy input or extraction required to affect transformation in either direction depends on the ambient thermal conditions and the heat transfer mechanisms available in the system. For example, a given amount of energy input may be insufficient to achieve the reverse phase transformation under some ambient thermal conditions, or may in fact damage the wire through overheating in other thermal conditions. To address this, the present invention takes advantage of a self-sensing capability of the SMA, in this case a change in electric resistance which occurs with both reverse and forward phase transformations.

The self-sensing capability of the SMA may be used to ascertain the combined effects of: i) present heat transfer conditions which remove thermal energy from the SMA and can be dynamic, ii) the mechanical tensile stress applied to the SMA which can vary in preloading or during actuation and affects the amount of energy required to cause SMA actuation, and iii) physical variations which affect the relative amount of energy required to cause the SMA to actuate as compared to other SMA actuators. In particular, when heating the SMA from the martensitic state, the combined effects of present heat transfer, mechanical loading conditions, and physical variations on the energy required for transformation are ascertained by searching for a subtle pattern in the electric resistance of the SMA. Specifically, upon sufficient heating of the SMA in the martensitic state, a condition is reached at which the electric resistance of the SMA undergoes a very slight increase followed by a decrease. This pattern in the electric resistance occurs at the onset of the reverse phase transformation of the SMA and potential actuator contraction. This phenomenon in the SMA resistance during heating from the martensitic phase is seen in FIG. 2 and referred to herein as the “heating cusp”. Conversely, when cooling the SMA from the austenitic state, the combined effects of present heat transfer, mechanical loading conditions, and physical variations are also ascertained by searching for a subtle pattern in the electric resistance of the SMA. Specifically, upon sufficient cooling of the SMA in the austenitic state, a condition is reached at which the electric resistance of the SMA undergoes a very slight decrease followed by an increase. This pattern in the electric resistance occurs at the onset of the forward phase transformation of the SMA and potential actuator expansion. This phenomenon in the SMA resistance during cooling from the austenitic phase is seen in FIG. 2 and referred to herein as the “cooling-cusp”. The heating-cusp and the cooling-cusp are referred to together herein as the “resistance-cusp” or simply as the “cusp”. As mentioned, during both heating leading to the reverse phase transformation (actuator contraction), and cooling leading to the forward phase transformation (actuator expansion), the absolute resistance profile can be affected by several factors (e.g. mechanical stress, physical variations, etc.). However, unlike prior solutions which use absolute resistance measurements to determine current material phase, the present invention uses relative resistance measurements and the resistance-cusp, the existence of which is not affected by said factors. In other words, the cusp occurs at the maximum relative resistance when heating towards the reverse phase transformation and the cusp occurs at the minimum relative resistance when cooling towards the forward phase transformation.

With regard to SMA actuation via the reverse phase transformation or via the forward phase transformation, faster and more consistent performance is attained in the presence of variable heat transfer, variable mechanical loading conditions, and physical variations by controlling the SMA in relation to the resistance-cusp. An electric signal may be alternately passed through the SMA, which is partly transformed into heat energy due to the electric resistance of SMA actuators, and arresting the electric signal to allow the SMA to cool. When starting from the martensitic state, upon sufficient heating to overcome any heat transfer away from the SMA, the SMA approaches some temperature, which can vary based on the mechanical loading and physical variations of the SMA, at which the reverse phase transformation in the crystalline structure of the SMA is about to occur. It is in this regime that the heating-cusp in the resistance occurs and is the precursor for reverse phase transformation actuation. In this state and condition, additional heating can induce the solid-state phase transformation to austenite causing an increase in the Young's modulus of the SMA and leading to potential SMA contraction. Conversely, when starting from the austenitic state, upon sufficient cooling of the SMA, the SMA approaches some temperature, which can vary based on the mechanical loading and physical variations of the SMA, at which the forward phase transformation in the crystalline structure of the SMA is about to occur. It is in this regime that the cooling-cusp in the resistance occurs and is the precursor for forward phase transformation actuation. In this state and condition, additional cooling can induce the solid-state phase transformation to martensite causing a reduction in the Young's modulus of the SMA and leading to potential SMA expansion.

As mentioned, probing involves determining the strength of the electric signal that causes the SMA to reach this subtle behavior in the resistance, the resistance-cusp. As also mentioned, priming involves applying the electric signal to the SMA so that the SMA remains in the regime of the resistance-cusp. The SMA may be “reverse primed” by holding it in the valley (of the electric resistance) adjacent to the cusp, as seen in FIG. 2. In this way, the SMA temperature is close to that which causes a phase transformation (either reverse or forward) so that the SMA remains in a primed state and motion can occur predictably and faster than if the SMA were not at the resistance-cusp. It is also possible to store in a memory the value of the electric signal strength that causes the SMA to be in the regime of the resistance-cusp so that the electric strength required to initiate or maintain actuation can be estimated for future actuation. In both cases, SMA actuation can be achieved with more consistent performance because variable heat transfer conditions, variable mechanical loading conditions, and physical variations are accounted for by identifying the onset of actuation via the resistance-cusp and controlling actuation around this regime.

Thus, in one embodiment, the method comprises the steps of identifying the cusp in the electric resistance of the SMA as an indicator of an onset of phase transformation, and applying an electric signal to the SMA so that the electric resistance remains within a specified regime of the cusp, thereby holding the SMA in the primed state to make subsequent actuation faster and more predictable than if the SMA were not being held in a primed state near its phase transformation. In a related embodiment, the method comprises the steps of identifying the cusp, storing the value of the corresponding electric signal, and applying an electric signal having the approximate stored value to the shape memory alloy to facilitate subsequent actuation. The SMA may be held at the resistance cusp for a very short period of time (e.g., less than 1 second) when actuation is required and there is little or no time to prime the SMA, or the SMA may be held at the resistance cusp for a longer period of time (e.g., more than one second) when a subsequent activation signal might occur and the SMA is held in the primed state. Phase transformation can be initiated by applying an electric signal having a value that is computed as a linear or nonlinear function of the value of the electric signal associated with the cusp.

Holding the SMA in the primed state at or near the cusp associated with phase transformation provides a number of advantages. One advantage is that the subsequent actuation cycle will not require time to heat the un-actuated SMA from the ambient conditions to the (potentially unknown) reverse phase transformation temperature, or cool the actuated SMA to the (potentially unknown) forward phase transformation temperature. Thus, both forward and reverse transformation actuations can take place from a primed state resulting in performance that is nearly invariable even if heat transfer, loading, or physical variations are present.

With regard to probing, exemplary techniques for identifying the cusp include the following. The heating cusp may be found, during heating of the SMA from a martensitic state, by identifying an electric resistance value which, upon further heating, is followed by a decrease in the electric resistance leading to a reverse phase transformation. Similarly, the cooling cusp may be found, during cooling of the SMA from an austenitic state, by identifying an electric resistance value which, upon further cooling, is followed by an increase in the electric resistance leading to a forward phase transformation.

Alternatively, the cusps may be found by applying a linear or nonlinear increasing electric signal, generally increasing in magnitude, to the SMA and measuring, estimating, or computing the slope of the electric resistance and identifying a positive slope followed by successive negative slopes for reverse phase transformation or identifying a negative slope followed by successive positive slopes for forward phase transformation. This may be accomplished using a ramp current or ramp duty cycle (in the case of PWM), and looking for either an dR/dt value that is less than some threshold, or using peak detection (i.e., comparing sequences of three points to determine whether the range contains a maximum or minimum).

Alternatively, the cusps may found using a mathematical, statistical, or experimental model to predict the magnitude of the electric signal that causes the SMA to be in a state in which the electric resistance of the SMA is at a cusp under current conditions of heat transfer, stress, and aging. This may be accomplished using a dynamic heating model, or a calibrated look-up table.

Alternatively, the cusps may be found using a mathematical or statistical model in conjunction with measured values to predict the magnitude of the electric signal that causes the SMA to be in a state in which the electric resistance of the SMA is at one of the cusps.

Alternatively, the cusps may be found using a mathematical operation, such as a correlation or pattern analysis, in conjunction with the electric resistance, voltage, or current to identify a cusp. This may be accomplished using peak detection or trough detection as a form of pattern analysis, but could also include variations using more than three points, such as windowed averages.

In some applications, it is desirable to achieve consistent performance with regard to the time required for actuation, from beginning to end. One solution is to base the electric signal strength on environmental temperature rather than the SMA's changing temperature. Another solution is to estimate the electric signal strength based on the SMA's resistance, including its derivatives (including PWM to get better signal to noise ratio).

In some applications, it may be desirable to probe with a slow ramping rate such that the SMA is almost at thermal equilibrium with the surroundings all the time in order to better detect the current at which the SMA will stay at its cusp. In other applications, especially applications in which adiabatic conditions can be assumed, a fast ramping rate can be used to increase speed and reduce heat transfer to the surrounding environment.

With regard to priming, exemplary techniques for bringing the SMA to a state in which it is close to transition (either forward in the case of cooling or reverse in the case of heating) include the following. Priming control can be open-loop, in which case the approximate electric signal strength may be determined through active periodic probing, or by taking independent measurements or estimates of ambient temperature, stress, and other associated variables, and using a calibration table (e.g., a “look-up table”). For example, the method may be implemented using an open-loop controller in which the applied signal strength is either offset or scaled from a pre-determined value (current, or PWM duty cycle). Alternatively, priming control can be closed-loop and use resistance feedback, in which case approximate target absolute resistance values may be determined through active periodic probing, or use the resistance derivative(s). For example, alternatively, the method may be implemented using a ramp (current or PWM duty cycle) based on a predetermined value, and then switching to a closed-loop controller which i) uses a predetermined value of resistance at the cusp as input to a feedback controller, ii) uses dR/dt as input to a feedback controller, or iii) uses peak/minimum detection and a bang-bang controller to heat/cool the system to maintain it at the resistance peak.

In one embodiment, the method further includes the step of achieving more consistent performance over a range of temperatures by inserting a temperature-varying resistor in series with the SMA so that, at lower temperatures, the electric resistance is low and the voltage across the shape memory alloy is high such that more power is transferred to the shape memory alloy, and, at higher temperatures, the electric resistance is high and the voltage across the shape memory alloy is low such that less power is transferred to the SMA. Relatedly, the voltage across the temperature-varying resistor can be input into a comparator such that priming is turned on or off based on ambient condition. Less power is needed at higher ambient temperatures and more power is needed at lower ambient temperatures for consistent performance. Thus, in addition to providing more consistent performance, the temperature-varying resistor protects the SMA from receiving excessive power.

With regarding to maintaining the SMA in the phase transformed state, exemplary subroutines for finding the maintenance duty cycle, Mtn_dty, are as follows. In one subroutine, whenever a new reading is taken:

sample_counter++;
if (R_new < R_old)
{
prev_neg_zero = 1;
R_met++;
}
else if ((R_new == R_old) && (prev_neg_zero == 1))
{
R_met++;
}
else
{
prev_neg_zero = 0;
}

In another subroutine, once per second:

percentage = R_met/sample_counter * 100.0;
if (percentage >= 70.0)
{
ProbingDone = 1;
Mtn_duty = duty;
}
else
{
duty ++; //increase PWM duty cycle
PWM_duty(duty);
}
sample_counter = 0;
R_met = 0;

Alternatively, rather than checking once per second, a moving window may be employed using a fixed number (e.g., 20) and making R_met a circular array containing the last state (1 or 0) whether R_new<R_old:

array_size = 20;
sample_counter++;
sample_counter = sample_counter%array_size; //take the remainder
if (R_new < R_old)
{
prev_neg_zero = 1;
R_met[sample_coutner] = 1;
}
else if ((R_new == R_old) && (prev_neg_zero == 1))
{
R_met[sample_coutner] = 1;
}
else
{
prev_neg_zero = 0;
R_met[sample_coutner] = 0;
}
R_met_sum = sum of all elements in the array R_met;
percentage = R_met_sum/array_size * 100.0;
if (percentage >= 70.0)
{
ProbingDone = 1;
Mtn_duty = duty;
}
else
{
duty ++; increase PWM duty cycle
PWM_duty(duty);
}

Open loop priming can be accomplished using some proportion, e.g., 50%, of Mtn_dty found via probing. Closed loop priming using SMA resistance or its derivative can be accomplished by priming a small distance from the cusp. For example, the SMA may be primed to dR/dt =0.1 or higher. When actuation is called for, the SMA can be quickly heated or cooled past the appropriate cusp to initiate phase (reverse or forward) transformation. Alternatively, peak resistance can be identified, and the SMA primed to 99% (or less) of peak resistance, and, when actuation is called for, the SMA can be quickly heated or cooled past the appropriate cusp to initiate the desired phase transformation.

In one implementation, closed loop priming involves servoing around the cusp at which the theoretical value of dR/dt is 0. However, dR/dt=0 at any resistance value provided that the current is constant and not causing actuation. Therefore, it may be desirable to first ramp up the duty cycle of the PWM signal to raise the temperature of the SMA to the point at which its resistance reaches the heating cusp leading towards the reverse phase transformation, and then the servo controller can be turned on. For example, the duty cycle of the PWM signal may be ramped up at the beginning of the priming period to a maximum duty cycle equal to 0.8×Mtn_duty. This avoids detection of zero gradients in the resistance curve which may exist at low duty cycles due to noise on the collected samples, and also starts peak detection at a point that is sufficiently close to the cusp. A peak detector may then be used to detect the cusp. Conversely, if the forward transformation is to be initiated, it may be desirable to ramp down the duty cycle of the PWM signal to reduce the temperature of the SMA to the point at which its resistance reaches the cooling cusp, and then the servo controller can be turned on. A trough detector may then be used to detect the cusp. Any of a number of commercially available peak and trough detection algorithms can be used for this purpose, as well as the algorithm introduced above. In a very simple implementation, a cusp may be considered to have been detected when the computed resistance values continue with the same slope polarity over three consecutive samples.

Once a heating peak is reached, a Bang-Bang controller may be used to maintain the resistance at the heating cusp by outputting a small duty cycle (allows cooling) and start to detect the peak resistance as the SMA temperature declines. The small duty cycle cannot be 0% or the voltage across the SMA and the current flowing through it will also be 0, in which case computing the resistance would be impractical. Once the heating cusp peak resistance is detected on cooling, the Bang-Bang controller may be used to maintain the resistance at the cusp by outputting a large duty cycle (heating) and start to detect the cusp on heating again. An exemplary algorithm for accomplishing this process is as follows:

Perform peak detection every time a new data is obtained
if (peak_dir == 1 && peak_detected == 1) //heating and peak detected
{
state = 0; // start to cool
peak_dir = −1; //start to look for cooling peak
}
else if (peak_dir == −1 && peak_detected == 1) //cooling and peak
detected
{
state = 1; //start to heat
peak_dir = 1; //start to look for heating peak
}

Conversely, when cooling actuation is desired and the associated cooling cusp resistance minimum is reached, a Bang-Bang controller may be used to maintain the resistance at the cooling cusp.

Alternatively, a linear or nonlinear controller may be used to maintain the resistance at the cusp rather than a Bang-bang control. The error used here can be the difference between the peak resistance and the current measured resistance for heat actuation, while for cooling actuation, the error used can be the difference between the minimum resistance and the current measured resistance.

In one contemplated application, the actuator is associated with a vehicle, and any one or more of the method steps, particularly the steps of identifying a cusp or initiating phase transformation, occur in response to receipt of a signal from a vehicle user or vehicle sensor.

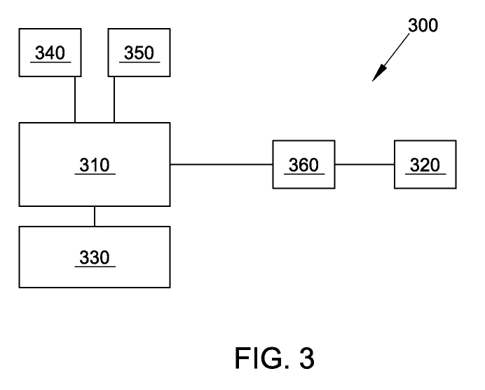

Referring to FIG. 3, a block diagram of an embodiment of a system 300 for implementing the method of the present invention is shown. The controller 310 is operatively connected to the SMA actuator 320. The controller 310 may also be operatively connected to a memory 330 for, e.g., storing the value determined during probing as corresponding to the cusp, and to a vehicle user device (e.g., key fob) 340 or vehicle sensor 350 (e.g., a pre-crash or crash sensor) for, e.g., providing a signal for initiating any of the steps of the method. The temperature-varying resistor 360 may be operatively connected in series with the SMA actuator 320. If such a resistor is used, many components in the Figure are optional.

The present invention has been described with reference to exemplary embodiments, configurations, and applications; it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment, configurations, or applications disclosed herein, but that the invention will include all embodiments, configurations, and applications falling within the scope of the appended claims. The terms “first,” “second,” and the like, as used herein do not denote any order, quantity, or importance, but rather are used to distinguish one element from another.

What is claimed is:

1. A method of controlling an actuator, wherein the actuator includes a shape memory alloy having an electric resistance, the method comprising the steps of:
identifying a cusp feature in the electric resistance of the shape memory alloy as an indicator of an onset of a phase transformation of the shape memory alloy; and
applying a priming signal to the shape memory alloy so that the electric resistance remains within a specified regime of the cusp, thereby holding the shape memory alloy in a primed state which facilitates subsequent actuation.

2. The method as set forth in claim 1, wherein the step of identifying the cusp feature includes the step of, during heating of the shape memory alloy from a martensitic state, identifying an electric resistance value which, upon further heating, is followed by a decrease in the electric resistance leading to a reverse phase transformation.

3. The method as set forth in claim 1, wherein the step of identifying the cusp feature includes the step of, during cooling of the shape memory alloy from an austenitic state, identifying an electric resistance value which, upon further cooling, is followed by an increase in the electric resistance leading to a forward phase transformation.

4. The method as set forth in claim 1, wherein the step of identifying the cusp feature includes the steps of:
applying an electric signal of increasing strength to the shape memory alloy;
determining a slope of the electric resistance;
identifying a positive slope followed by successive negative slopes for reverse phase transformation.

5. The method as set forth in claim 1, wherein the step of identifying the cusp feature includes the steps of:
applying an electric signal of decreasing strength to the shape memory alloy;
determining a slope of the electric resistance;
identifying a negative slope followed by successive positive slopes for forward phase transformation.

6. The method as set forth in claim 1, wherein the step of identifying the cusp feature includes the step of using a model to predict a strength of the electric signal corresponding to the cusp under existing conditions.

7. The method as set forth in claim 1, wherein the step of identifying the cusp feature includes the step of using a model in conjunction with measured values for electric resistance.

8. The method as set forth in claim 1, wherein the step of identifying the cusp feature includes the step of using a mathematical operation in conjunction with measured values for electric resistance.

9. The method as set forth in claim 1, further including the step of achieving consistent performance over a range of temperatures by inserting a temperature-varying resistor in series with the shape memory alloy so that, at lower temperatures, the electric resistance is lower and a voltage across the shape memory alloy is higher such that more power is transferred to the shape memory alloy, and, at higher temperatures, the electric resistance is higher and the voltage across the shape memory alloy is lower such that less power is transferred to the shape memory alloy.

10. The method as set forth in claim 1, further including the step of initiating the phase transformation in the shape memory alloy by applying an initiation signal that is a function of the maintenance signal.

11. The method as set forth in claim 10, wherein the actuator is associated with a vehicle, and further including the step of applying the initiation signal in response to one of a user of the vehicle and a vehicle sensor.

12. The method as set forth in claim 1, wherein the actuator includes dummy and main shape memory alloy elements exposed to a zone of ambient conditions, and the method further includes the steps of:
applying an initiation signal to a dummy shape memory alloy element;
determining a slope of the electric resistance in the dummy element, so as to determine the cusp and feedback; and
applying the priming signal to the main shape memory alloy element based on the feedback.

13. A method of controlling an actuator, wherein the actuator includes a shape memory alloy having an electric resistance, the method comprising the steps of:
identifying a cusp feature in the electric resistance of the shape memory alloy as an indicator of an onset of a phase transformation of the shape memory alloy, wherein the cusp feature is associated with a value of an electric signal applied to the shape memory alloy;
storing the value of the electric signal in a memory; and
applying the electric signal having the approximate stored value to the shape memory alloy to facilitate actuation.

14. The method as set forth in claim 13, wherein the step of identifying the cusp feature includes the step of, during heating of the shape memory alloy from a martensitic state, identifying an electric resistance value which, upon further heating, is followed by a decrease in the electric resistance leading to a reverse phase transformation.

15. The method as set forth in claim 13, wherein the step of identifying the cusp feature includes the step of, during cooling of the shape memory alloy from an austenitic state, identifying an electric resistance value which, upon further cooling, is followed by an increase in the electric resistance leading to a forward phase transformation.

16. The method as set forth in claim 13, wherein the step of identifying the cusp feature includes the steps of:
applying an electric signal of increasing strength to the shape memory alloy;
determining a slope of the electric resistance;
identifying a positive slope followed by successive negative slopes for reverse phase transformation.

17. The method as set forth in claim 13, wherein the step of identifying the cusp feature includes the steps of:
applying an electric signal of decreasing strength to the shape memory alloy;
determining a slope of the electric resistance;
identifying a negative slope followed by successive positive slopes for forward phase transformation.

18. The method as set forth in claim 13, wherein the step of identifying the cusp feature includes the step of using a model to predict a strength of the electric signal corresponding to the cusp under existing conditions.

19. The method as set forth in claim 13, wherein the step of identifying the cusp feature includes the step of using a mathematical operation or mathematical model in conjunction with measured values for electric resistance.

20. The method as set forth in claim 13, further including the step of initiating the phase transformation in the shape memory alloy by applying an initiation signal that is a function of the maintenance signal.

21. The method as set forth in claim 20, wherein the actuator is associated with a vehicle, and further including the step of applying the initiation signal in response to one of a user of the vehicle and a vehicle sensor.
